(19) United States
(12) Patent Application Publication
(10) Pub. No.: US 2013/0151872 A1
(43) Pub. Date: Jun. 13, 2013

(54) POWER SUPPLY DEVICE AND COMPUTER SERVER USING THE SAME

(71) Applicants: CHIH-TA LIOU, Tu-Cheng (TW); JYUN-DA LIAO, Tu-Cheng (TW)

(72) Inventors: CHIH-TA LIOU, Tu-Cheng (TW); JYUN-DA LIAO, Tu-Cheng (TW)

(21) Appl. No.: 13/653,437

(22) Filed: Oct. 17, 2012

(30) Foreign Application Priority Data
Dec. 12, 2011 (TW) 100145695

(51) Int. Cl. G06F 1/26

(52) U.S. Cl. 713/300

(57) ABSTRACT

A power supply device for a server device includes a power supply circuit, a control microchip, and a compensation element. The compensation element is a resistor having a negative temperature coefficient. The control microchip controls the power supply circuit to generate an output voltage to power the server device in response to receiving a voltage of an external power supply. When the power supply device generates excessive heat in use, a resistance of the compensation element decreases to maintain a total resistance of the power supply device at substantially an original value.

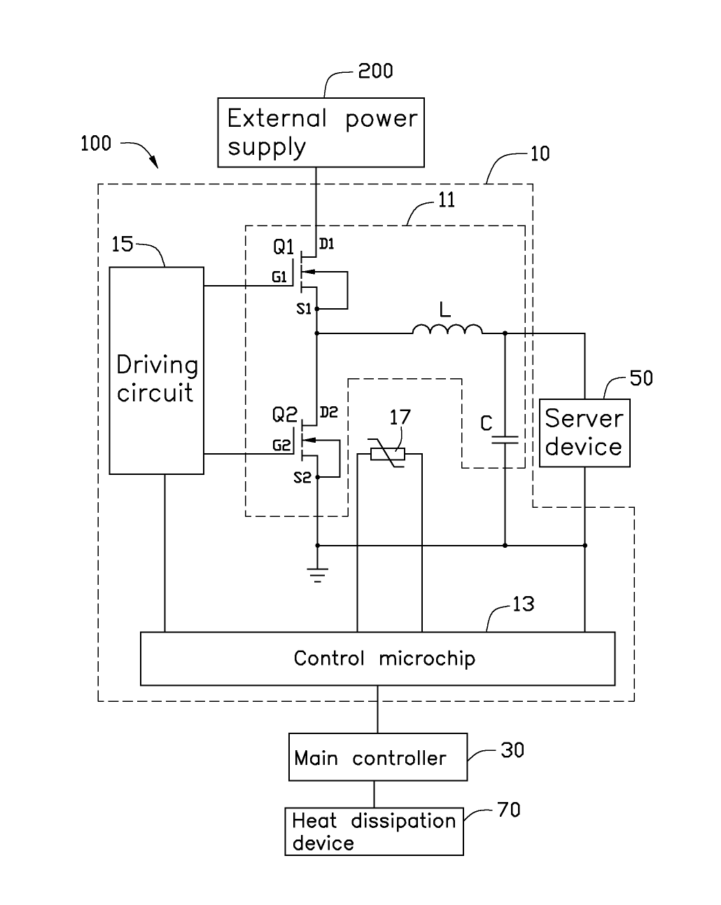

### BACKGROUND

1. Technical Field

The present disclosure relates to power supply devices, and particularly to a power supply device for computer servers and a computer server using the power supply device.

2. Description of Related Art

A power supply device for computer servers may include a controller, a driving circuit, and a power supply circuit. The controller is electrically connected to the power supply circuit via the driving circuit, and the power supply circuit is electrically connected between an external power supply (e.g., a wall socket) and a computer server. In use, the controller controls the power supply circuit to turn on via the driving circuit. When the power supply circuit is turned on, it adjusts a voltage of the incoming external power supply to a predetermined value, and outputs the adjusted voltage to the computer server for use of the computer server.

In the above-described power supply device, the power supply circuit may include many resistors. Most resistors have positive temperature coefficients. That is, when a temperature of such a resistor increases, the electrical resistance of the resistor increases too. In the power supply device, temperatures of the resistors of the power supply circuit may increase due to heat generated by the power supply device, and resistances of the resistors may increase correspondingly. Thus, much electrical power may be consumed by the resistors, and a power supply efficiency of the power supply device may be low.

Therefore, there is room for improvement within the art.

### BRIEF DESCRIPTION OF THE DRAWINGS

Many aspects of the present disclosure can be better understood with reference to the following drawing. In the drawing, the emphasis is placed upon clearly illustrating the principles of the present disclosure.

The drawing is a block diagram of a computer server, according to an exemplary embodiment.

### DETAILED DESCRIPTION

The drawing is a block diagram of a computer server 100, according to an exemplary embodiment. The computer server 100 includes a power supply device 10, a main controller 30, a server device 50, and a heat dissipation device 70. The power supply device 10 electrically connects the server device 50 to an external power supply 200 (e.g., a wall socket or a battery), and allows electrical power of the external power supply 200 to pass to the server device 50. The main controller 30 detects a current temperature inside the computer server 100, and controls the heat dissipation device 70 to cool down the computer server 100 when the current temperature inside the computer server 100 exceeds a predetermined threshold value.

The power supply device 10 includes a power supply circuit 11, a control microchip 13, a driving circuit 15, and a compensation element 17. The power supply circuit 11 includes a first switch Q1, a second switch Q2, an inductor L, and a capacitor C. Both the first switch Q1 and the second switch Q2 are metal-oxide-semiconductor field-effect transistors (MOSFETs). The first switch Q1 includes a gate G1, a source S1, and a drain D1, and the second switch Q2 includes a gate G2, a source S2, and a drain D2. The source S1 of the first switch Q1 is electrically connected to the drain D2 of the second switch Q2, and the source S2 of the second switch Q2 is grounded. The inductor L and the capacitor C are electrically connected in series between the source S1 of the first switch Q1 and ground.

Both the gate G1 of the first switch Q1 and the gate G2 of the second switch Q2 are electrically connected to the driving circuit 15. The driving circuit 15 is electrically connected to the control microchip 13. The compensation element 17 can be a resistor having a negative temperature coefficient. That is, when a temperature of the compensation element 17 increases, a resistance of the compensation element decreases. Both ends of the compensation element 17 are electrically connected to the control microchip 13. In practice, the compensation element 17 is positioned adjacent to an element of the computer server 100 that generates the most heat when the computer server 100 is working. In this embodiment, the second switch Q2 is assumed to generate more heat than any other element of the computer server 100 when the computer server 100 is working, and thus the compensation element 17 is positioned adjacent to the second switch Q2.

The main controller 30 can be a base management controller (BMC) or a basic input-output system (BIOS). The server device 50 can be a common computer server device. The heat dissipation device 70 can be a fan. The main controller 30 is electrically connected to the control microchip 13, and the heat dissipation device 70 is electrically connected to the main controller 30. The server device 50 and the capacitor C are electrically connected in parallel between the inductor L and ground. Furthermore, the server device 50 is electrically connected to the control microchip 13.

In use of the computer service 100, the external power supply 200 is electrically connected to the drain D1 of the first switch Q1. The control microchip 13 detects the type of the server device 50, and determines a suitable power supply voltage for the server device 50. After determining the power supply voltage, the control microchip 13 generates a pulse width modulation (PWM) signal and sends the PWM signal to the driving circuit 15. In response to receiving pulses of the PWM signal, the driving circuit 15 turns on the first switch Q1 and turns off the second switch Q2, so that the external power supply 200 charges the capacitor C via the first switch Q1 and the inductor L. In response to time intervals occuring between the pulses of the PWM signal, the driving circuit 15 turns off the first switch Q1 and turns on the second switch Q2, so that the capacitor C discharges and generates an output voltage. The output voltage is input to the server device 50 to supply electrical power to the server device 50.

As one of ordinary skill in the art knows, an effective value of the output voltage can be adjusted by means of adjusting a duty ratio of the PWM signal. In this way, the power supply device 10 can provide an output voltage with a suitable value (e.g., the power supply voltage determined by the control microchip 13) to the server device 50. Furthermore, if the voltage to the server device 50 requires adjusting, the server device 50 can send a request signal to the control microchip 13, so that the control microchip 13 adjusts the effective value of the output voltage according to the request signal.

When the computer server 100 is working, it typically generates significant heat, and a temperature inside the computer server 100 increases. Since normal resistors (not shown) and other electronic elements (not shown) of the computer server 100 may have positive temperature coefficients, the respective resistances of all these electronic elements may increase. However, since the compensation element 17 has a negative temperature coefficient, the electrical resistance of the compensation element 17 decreases, so that a total resistance of the power supply device 10 remains at a value which is substantially the original value. In this way, the consumption of electrical power by the power supply device 10 itself is prevented from significantly increasing, and the power supply device 10 maintains efficient use of the external power supply 200 within an acceptable range.

Furthermore, when the computer server 100 is working, the control microchip 13 reads the current temperature inside the computer server 100 according to the changeable resistance of the compensation element 17, and transmits a value of the current temperature to the main controller 30. If at any time the value of the current temperature exceeds a predetermined threshold value, the main controller 30 controls the heat dissipation device 70 to cool down the computer server 100.

In other embodiments, the control microchip 13 can be integrated within the main controller 30.

In other embodiments, the driving circuit 15 turns off the first switch Q1 and turns on the second switch Q2 in response to receiving pulses of the PWM signal, and turns on the first switch Q1 and turns off the second switch Q2 during the time intervals between the pulses of the PWM signal.

It is to be further understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. A power supply device for a server device, comprising:
a power supply circuit electrically connected to the server device and an external power supply;
a control microchip electrically connected to the power supply circuit; and
a compensation element electrically connected to the control microchip, the compensation element being a resistor having a negative temperature coefficient;
wherein the control microchip controls the power supply circuit to generate an output voltage utilized by the server device in response to receiving a voltage of the external power supply; and when the power supply device generates excessive heat in use, a resistance of the compensation element decreases due to the excessive heat, thereby maintaining a total resistance of the power supply device substantially at an original value.

2. The power supply device of claim 1, further comprising a driving circuit electrically connected between the control microchip and the power supply circuit.

3. The power supply device of claim 2, wherein the power supply circuit includes a first switch, a second switch, an inductor, and a capacitor; the first switch and the second switch are electrically connected in series between the external power supply and ground, and are both electrically connected to the driving circuit; the inductor and the capacitor are electrically connected in series between the first switch and ground; and the server device and the capacitor are electrically connected in parallel between the inductor and ground.

4. The power supply device of claim 3, wherein when the control microchip turns on the first switch and turns off the second switch via the driving circuit, the external power supply charges the capacitor via the first switch and the inductor; and when the control microchip turns off the first switch and turns on the second switch via the driving circuit, the capacitor discharges and generates the output voltage utilized by the server device.

5. The power supply device of claim 4, wherein the control microchip sends a pulse width modulation (PWM) signal to the driving circuit to turn on and off the first switch and the second switch; and the driving circuit turns on one of the first and second switches and turns off the other of the first and second switches in response to receiving pulses of the PWM signal, and turns off the one of the first and second switches and turns on the other of the first and second switches in response to time intervals occurring between the pulses of the PWM signal.

6. The power supply device of claim 4, wherein both the first and second switches are metal-oxide-semiconductor field-effect transistors (MOSFETs), and each of the first and second switches includes a gate, a source, and a drain; the source of the first switch is electrically connected to the drain of the second switch, and the source of the second switch is grounded; and the inductor and the capacitor are electrically connected in series between the source of the first switch and ground.

7. A computer server, comprising:
a server device; and
a power supply device, including:
a power supply circuit electrically connected to the server device and an external power supply;
a control microchip electrically connected to the power supply circuit; and
a compensation element electrically connected to the control microchip, the compensation element being a resistor having a negative temperature coefficient;
wherein the control microchip controls the power supply circuit to generate an output voltage utilized by the server device in response to receiving a voltage of the external power supply; and when the power supply device generates excessive heat in use, a resistance of the compensation element decreases due to the excessive heat, thereby maintaining a total resistance of the power supply device substantially at an original value.

8. The computer server of claim 7, wherein the power supply device further includes a driving circuit electrically connected between the control microchip and the power supply circuit.

9. The computer server of claim 8, wherein the power supply circuit includes a first switch, a second switch, an inductor, and a capacitor; the first switch and the second switch are electrically connected in series between the external power supply and ground, and are both electrically connected to the driving circuit; the inductor and the capacitor are electrically connected in series between the first switch and ground; and the server device and the capacitor are electrically connected in parallel between the inductor and ground.

10. The computer server of claim 9, wherein when the control microchip turns on the first switch and turns off the second switch via the driving circuit, the external power supply charges the capacitor via the first switch and the inductor; and when the control microchip turns off the first switch and turns on the second switch via the driving circuit, the capacitor discharges and generates the output voltage utilized by the server device.

11. The computer server of claim 10, wherein the control microchip sends a pulse width modulation (PWM) signal to the driving circuit to turn on and off the first switch and the second switch; and the driving circuit turns on one of the first and second switches and turns off the other of the first and second switches in response to receiving pulses of the PWM signal, and turns off the one of the first and second switches and turns on the other of the first and second switches in response to time intervals occurring between the pulses of the PWM signal.

12. The computer server of claim 11, wherein the control microchip adjusts an effective value of the output voltage utilized by the server device by means of adjusting a duty ratio of the PWM signal in response to receiving a request signal from the server device.

13. The computer server of claim 10, wherein both the first and second switches are metal-oxide-semiconductor field-effect transistors (MOSFETs), and each of the first and second switches includes a gate, a source, and a drain; the source of the first switch is electrically connected to the drain of the second switch, and the source of the second switch is grounded; and the inductor and the capacitor are electrically connected in series between the source of the first switch and ground.

14. The computer server of claim 7, wherein the compensation element is positioned adjacent to an element of the computer server that generates most heat when the computer server works.

15. The computer server of claim 7, further comprising a main controller electrically connected to the control microchip and a heat dissipation device electrically connected to the main controller; wherein the control microchip detects a temperature inside the computer server according to a resistance of the compensation element, and transmits a value of the temperature to the main controller; and the main controller controls the heat dissipation device to cool down the computer server when the value of the temperature exceeds a predetermined threshold value.
